(19) United States
(12) Patent Application Publication
(10) Pub. No.: US 2024/0220804 A1
(43) Pub. Date: Jul. 4, 2024

(54) DEVICE AND METHOD FOR CONTINUAL LEARNING BASED ON SPECULATIVE BACKPROPAGATION AND ACTIVATION HISTORY

(71) Applicant: KOREA UNIVERSITY RESEARCH AND BUSINESS FOUNDATION, Seoul (KR)

(72) Inventors: Sangwoo PARK, Suwon-si (KR); Taeweon SUH, Namyangju-si (KR)

(73) Assignee: KOREA UNIVERSITY RESEARCH AND BUSINESS FOUNDATION, Seoul (KR)

(21) Appl. No.: 18/356,360

(22) Filed: Jul. 21, 2023

(30) Foreign Application Priority Data
Jul. 22, 2022 (KR) 10-2022-0090968

(51) Int. Cl. G06N 3/084; G06N 3/048

(52) U.S. Cl. CPC G06N 3/084; G06N 3/048

(57) ABSTRACT

Disclosed is a continual learning method for a deep learning model. The continual learning method of the deep learning model is performed by a computing device including at least a processor and, for continual learning for a second task and an n^{th} task for the deep learning model trained for a first task, includes a forward propagation operation of performing a forward propagation; a backward propagation operation of performing a backward propagation; and a weight update operation of performing a weight update, wherein the forward propagation operation, the backward propagation operation, and the weight update operation are repeatedly performed, and the update operation is performed based on an activation tendency of each of neurons included in the deep learning model, in a process in which training for the first task proceeds.

### TECHNICAL FIELD

The present invention relates to artificial intelligence (AI) and more particularly, to a device and method for improving continual learning (also, referred to as life-long learning) performance of deep learning.

### RELATED ART

Continual learning (also, referred to as life-long learning) of deep learning aims that a single deep learning model continuously learns data of various domains in a gradual manner. However, there is an issue called catastrophic forgetting that, when a trained model learns data of other domain, the trained model forgets previously learned knowledge.

To solve such catastrophic forgetting issue, proposed are methodologies, such as elastic weight consolidation (EWC) method or a synaptic intelligence (SI) method, which find a model weight playing an important role in a previously trained domain and prevent the corresponding weight to not be updated when training another domain. The EWC method or the SI method effectively mitigates catastrophic forgetting and is used as a state-of-the-art criterion in continual learning.

The EWC method finds an important weight from a domain based on a Fisher information matrix and the SI technique finds an important weight from a domain based on the entire gradients of the model. However, a large computational amount is required to calculate the entire gradients of the model or the Fisher information matrix, which greatly increases a training time.

Unlike the existing methods, the present invention proposes a method that does not require an additional operation by finding an important weight based on activation history. Also, the present invention optimizes speculative backpropagation that performs training with past knowledge and applies the same to continual learning. For example, the present invention proposes a device and method that may effectively mitigate catastrophic forgetting and may also accelerate a training speed through parallel training using speculative backpropagation.

### DETAILED DESCRIPTION

### Subject

A technical objective to be achieved by the present invention is to provide a device and method that may mitigate a catastrophic forgetting issue occurring in a continual learning process in which a deep learning model learns data of various domains and may accelerate a training speed.

### Solution

A continual learning method of a deep learning model according to an example embodiment of the present invention is performed by a computing device including at least a processor, and for continual learning for a second task and an n^{th} task for the deep learning model trained for a first task, includes a forward propagation operation of performing a forward propagation; a backward propagation operation of performing a backward propagation; and a weight update operation of performing a weight update, wherein the forward propagation operation, the backward propagation operation, and the weight update operation are repeatedly performed, and the update operation is performed based on an activation tendency of each of neurons included in the deep learning model, in a process in which training for the first task proceeds.

Also, a method of training a deep learning model according to an example embodiment of the present invention is performed by a computing device including at least a processor, and includes a forward propagation operation of performing a forward propagation; a backward propagation operation of performing a backward propagation; and a weight update operation of performing a weight update, wherein the forward propagation operation, the backward propagation operation, and the weight update operation are repeatedly performed, and the forward propagation operation and the backward propagation operation that are repeatedly performed after an initial execution proceed in parallel at least once.

### Effect

According to a device and method for training a deep learning model based on speculative backpropagation and activation history according to an example embodiment of the present invention, it is possible to mitigate a catastrophic forgetting issue occurring in a continual learning process in which a deep learning model learns data of various domains.

Also, it is possible to accelerate a training speed of continual learning for a deep learning model through parallel training using speculative backpropagation.

### BRIEF DESCRIPTION OF DRAWINGS

FIG. 1 illustrates an example for explaining a method of performing speculative backpropagation (SB).

FIG. 2 illustrates an example of neurons activated in task 1 and task 2.

FIG. 3 is a diagram illustrating a configuration of a device for training a deep learning model based on speculative backpropagation and/or activation history according to the present invention.

### Mode

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Example embodiments of the present invention are described with reference to the accompanying drawings. However, the scope of the claims is not limited to or restricted by the example embodiments. Like reference numerals proposed in the respective drawings refer to like elements.

Hereinafter, example embodiments of the present invention are described in detail with reference to the accompanying drawings. However, the scope of the patent application is not limited to or restricted by the example embodiments. Like reference numerals in the respective drawings refer to like elements. Also, it may be understood that at least a portion of each of operations included in methods described in the following is performed by a computing device (or a processor included in the computing device). Also, detailed description related to a method and/or a device described herein may refer to the paper published by the inventors of the present invention (Sangwoo PARK, and Taeweon SUH, “Continual Learning With Speculative backpropagation and Activation History.”, IEEE Access, Apr. 11, 2022.).

### The Neural Network Training

To train a neural network, three processes, forward propagation, backward propagation, and weight update, need to sequentially proceed and the three processes may be repeatedly performed until a predetermined goal is achieved (e.g., until a target error rate is reached).

In the forward propagation, data is propagated from an input layer to an output layer. Each neuron computes a weighted sum of inputs from connected neurons in its prior layer and then adds a value calculated as shown in Equation 1 with a bias. An output of a neuron goes through an activation function that determines data to pass to a next layer. Widely used activation functions include Rectified Linear Unit (ReLU), Tanh, and Sigmoid. In particular, ReLU that is an activation function defined by Equation 2 involves superior performance and simple calculation and is used in many deep neural networks (DNNs). The ReLU propagates zero to a next layer when an input is negative (i.e., when a corresponding neuron is deactivated) and otherwise (i.e., when the corresponding neuron is activated), bypasses an input value to a next layer (i.e., bypasses the input value to the next layer as is). Therefore, only the activated neuron may affect a speculation result of a deep learning model. In an output layer, the Softmax function of Equation 3 is widely used. The Softmax function computes a probability distribution of outcomes (y_{z}⁰).

$${u}_{j}^{l} = {\sum }_{i = 1}^{N} {w}_{ij}^{l} {x}_{i}^{l} + {Bias}^{l} \qquad [ Equation 1 ]$$

$${y}_{j}^{l} = max ( 0 , {u}_{j}^{l} ) \qquad [ Equation 2 ]$$

$${y}_{z}^{o} = \frac{{e}^{{u}_{z}^{o}}}{{\sum }_{i = 1}^{n} {e}^{{u}_{i}^{o}}} \qquad [ Equation 3 ]$$

In the above equations, 1≤i≤N, 1≤l≤0 (i, j, z, k=neuron index, 1=layer index).

Backward propagation (backpropagation) is used to adjust weights (wᵢⱼ^{j}) by calculating derivates. The backpropagation starts from the output layer based on, for example, Softmax. The derivative in the output layer is expressed in Equation 4. That is, Equation 4 calculates a difference between a forward propagation outcome (y_{z}⁰) and a target output (t_{z}). The derivative of an error related to a weight is calculated according to Equation 5. The derivative of ReLU activation function is calculated according to Equation 6, which has a value of 0 when the outcome of Equation 2 is zero and has a value of 1, otherwise.

$$\frac{dE}{{dy}_{z}^{o}} = {y}_{z}^{o} - {t}_{z} \qquad [ Equation 4 ]$$

$$\frac{dE}{{dy}_{k}^{l}} = {\sum }_{z} {w}_{kz}^{l + 1} \frac{dE}{{dy}_{z}^{l + 1}} \qquad [ Equation 5 ]$$

$${δ}_{k}^{l} = \frac{dE}{{du}_{k}^{l}} = \frac{dE}{{dy}_{k}^{l}} \frac{{dy}_{k}^{l}}{{du}_{k}^{l}} \qquad [ Equation 6 ]$$

In DNN training, weights are adjusted based on errors computed in the backpropagation. Initially, as in Equation 7, Δwᵢⱼ^{j} is calculated by multiplying backpropagation outcome δᵢ^{l} by forward propagation outcome yⱼ^{j-1} Then, weights (wᵢⱼ^{j}) are updated according to Equation 8. Here, a learning rate η determines a degree of learning. This process is repeated for all the weights.

$$Δ {w}_{ij}^{l} = {δ}_{i}^{l} {y}_{j}^{l - 1} \qquad [ Equation 7 ]$$

$${w}_{ij}^{l} = {w}_{ij}^{l} - {Δw}_{ij}^{l} η \qquad [ Equation 8 ]$$

### Mitigating Catastrophic Forgetting

Hereinafter, a method for mitigating catastrophic forgetting is described in detail. In detail, speculative backpropagation and activation history may be used. Each method may be implemented in a multi-layer perceptron with two hidden layers (400 neurons in each layer), but it will be apparent that the scope of the present invention is not limited thereto. Also, the aforementioned two methods may be used alone or in combination (simultaneously).

A. Softmax History and Biased ReLU with Speculative Backpropagation (SB)

In artificial neural network (ANN) training, backpropagation is performed based on forward propagation outcome. It represents that the backpropagation may be performed only after the forward propagation is completed. However, speculative backpropagation (SB) proposed herein enables a simultaneous operation (or parallel operation) of the forward propagation and the backward propagation. That is, the speculative backpropagation (SB) refers to technology that may accelerate a training speed by simultaneously performing the forward propagation and the backward propagation based on past knowledge. The speculative backpropagation (SB) is based on the observation result that Softmax and ReLU outcomes for the same labels are similar in near-forward propagations, for example, outcome in at least one previous forward propagation.

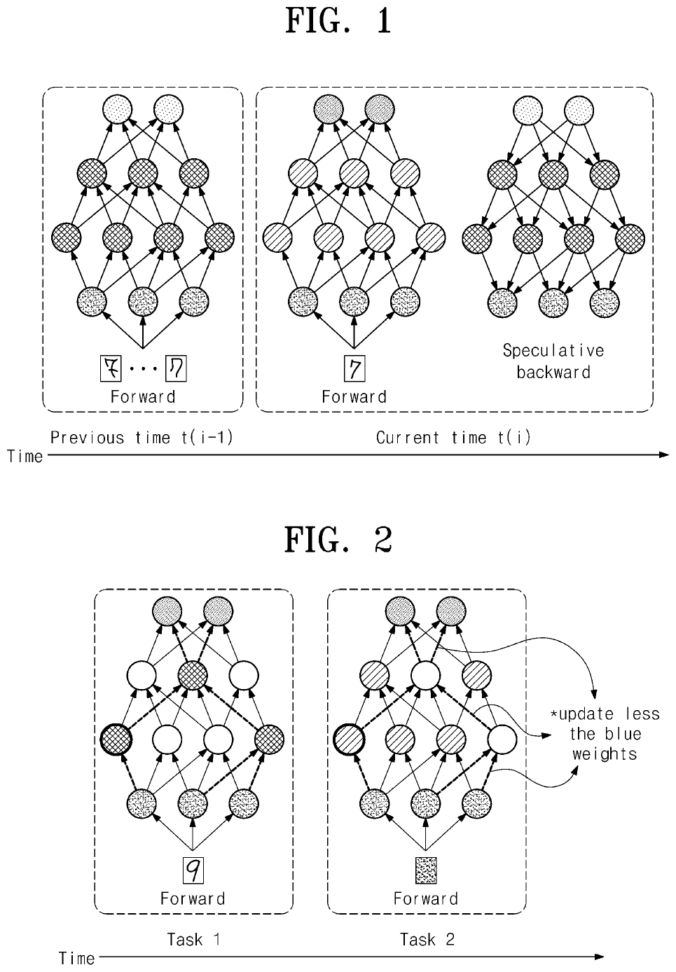

FIG. 1 illustrates an example for explaining a method of performing SB. That is, FIG. 1 illustrates an example of speculating a current forward propagation based on an activation function result (activation status of an activation function) of a previous forward propagation and a speculation result and performing the forward propagation and the backward propagation in parallel. At a current time t(i), the backpropagation is performed based on Softmax history and previous ReLU outcomes depicted in red neurons and blue neurons, respectively. It breaks the inherently sequential nature of stochastic gradient descent (SGD) in backward computation, enabling the simultaneous operation (or parallel operation) of the forward and backward propagations. The speculative backpropagation (SB) checks speculation correctness based on a threshold. If difference between a current Softmax output and a speculated result is greater than the threshold, the speculated execution is nullified and the backpropagation is performed again using the current Softmax output. That is, if a difference between the current Softmax outcome at t(i) and the speculated one at t(i) is greater than the threshold, the backpropagation execution performed in parallel may be nullified and the backpropagation may be performed again based on the current Softmax outcome. According to the experiment related thereto, the reciprocal of the number of classes in a dataset may be a good candidate for the threshold. Although the threshold is set to 0.1 herein, the present invention is not limited to a specific numerical value of the threshold and the threshold may vary according to managers or circumstances. Also, more details related to the speculative backpropagation may reference the paper by S. Park et al. (S. Park and T. Suh, “Speculative backpropagation for CNN parallel training,” IEEE Access, vol. 8, pp. 215365-215374, 2020.).

In addition to a continuous operation (parallel performing of forward and backward propagations), the SB also helps preserve previously learned knowledge for continual learning. In the previously cited paper by S. Park et al. (2020), the Softmax history is updated using Equation 9. In Equation 9, α and β are weights for current and accumulated Softmax outcomes, respectively. Setting α and β to 0.5 showed reducing a training time while providing comparable or even better accuracy. For continual learning, the experiment was performed by changing values of α and β. Table 1 shows the experiment result. In detail, Table 1 shows accuracy of task 1 after sequentially training Permuted MNISTs (task 1 to task 4). It can be known from the result of Table 1 that assigning a more weight to β may better mitigate catastrophic forgetting. It is because the past knowledge is likely to be preserved with a more weight on history. Accuracy of task 1 is highest when α=0.2 and β=0.8.

That is, the speculative backpropagation (SB) estimates the current speculation result by accumulating past forward propagation speculation results and its performance varies depending on which of past and current results is accumulated with more weight. To optimize the speculative backpropagation for continual learning, a greater weight may be assigned to the past result, which may make it possible to preserve knowledge. As a result of the experiment, the catastrophic forgetting issue may be greatly mitigated when a ratio of past and current weights is set to 8:2 in Equation 9. However, it is obvious that the scope of the present invention is not limited to a specific ratio of weights. Also, the speculative backpropagation (SB) speculates the current activation outcome with ReLU activation outcome of previous forward propagation. Herein, like Algorithms 1 and 2, it may be optimized for continual learning through speculation with accumulation of activation history. As a result of speculation with the activation history, the past knowledge may be effectively preserved.

$${y}_{l ( i )}^{{o}^{′}} = ( {y}_{l ( i )}^{o} α ) + {y}_{l ( i - 1 )}^{{o}^{′}} β ) where ( α + β = 1 ) \qquad [ Equation 9 ]$$

yₜ₍ᵢ₎⁰=current Softmax outcome.

yₜ₍ᵢ₋₁₎⁰=accumulated Softmax outcome until time t(i-1)

TABLE 1

| | Hyperparameters value | | | | | | | | |
|---|---|---|---|---|---|---|---|---|---|
| | α = 0.1 | α = 0.2 | α = 0.3 | α = 0.4 | α = 0.5 | α = 0.6 | α = 0.7 | α = 0.8 | α = 0.9 |
| | β = 0.9 | β = 0.8 | β = 0.7 | β = 0.6 | β = 0.5 | β = 0.4 | β = 0.3 | β = 0.2 | β = 0.1 |
| MNIST handwritten | 90.78% | 91.15% | 91.14% | 88.86% | 88.19% | 86.92% | 83.57% | 82.3% | 81.99% |
| SB accuracies | | | | | | | | | |
| MNIST Fashion | 52.02% | 52.22% | 52.2% | 51.71% | 50.1% | 48.21% | 43.77% | 41.52% | 40.08% |
| SB accuracies | | | | | | | | | |

The SB performs backpropagation using the most recent ReLU outcome. In the case of continual learning, considering both the most recent ReLU outcome and history of ReLU helps preserve knowledge. Algorithm 1 refers to an algorithm related to a method of reflecting an activation outcome and defines f(uⱼ), referred to as biased ReLU. Depending on example embodiments, the biased ReLU may also be referred to as adjusted ReLU, accumulated ReLU, and the like. The biased ReLU is adjusted by the current activation outcome whenever the forward propagation is completed. When a neuron is deactivated, the biased ReLU becomes closer to 0. When the neuron is activated, the biased ReLU becomes closer to 1.

[Algorithm 1]
Algorithm 1 Biased ReLU According to Activation History

1: f(uⱼ^{l}): current ReLU output, f(uⱼ^{l})′: biased ReLU
2: if f(uⱼ^{l}) == 0 do (when ReLU output is zero)
3: f(uⱼ^{l})′ ← f(uⱼ^{l})′/2; (ReLU is biased towards 0)
4: Else
5: f(uⱼ^{l})′ ← (f(uⱼ^{l})′ + 1)/2; (ReLU is biased towards 1)
6: Where biased ReLU f(uⱼ^{l})′ : (0 <= f(uⱼ^{l})′ <= 1)

Algorithm 2 refers to an algorithm related to a method of speculating (or inferring) activation of a neuron based on the biased ReLU. When the biased ReLU is smaller than 0.5, the neuron is speculated to be deactivated. Otherwise (i.e., when the biased ReLU is greater than or equal to 0.5), the neuron is speculated to be activated. When SB is performed based on Algorithm 1 and Algorithm 2, accuracies of a previous task were higher by 2.3% and 1.9% on average for Permuted Handwritten and Fashion, respectively.

[Algorithm 2]
Algorithm 2 ReLU Outcome Speculation

| | |
|---|---|
| 1: | if f(uⱼ^{l})′ < 0.5 do (when biased ReLU is smaller |
| | than 0.5) |
| 2: | δₖ^{l} ← 0; (speculate as the deactivation of the neuron) |
| 3: | else |
| 4: | δₖ^{l} ← 1; (speculate as the activation of the neuron) |

As described above, a forward propagation outcome at a time t(i) may be speculated using a Softmax outcome (output of the deep learning model) and an activation outcome of an activation function at a time t(i-2) and a Softmax outcome and an activation outcome of the activation function at a time t(i-1). In detail, speculating the forward propagation outcome at the time t(t) using Softmax may speculate the Softmax outcome at the time t(i) by multiplying the Softmax outcome at the time t(i-1) and the Softmax outcome at the time t(i-2) by the respective weights and then summing the same. Here, the catastrophic forgetting issue may be mitigated and the training speed may be reduced according to a weight to be multiplied. Also, an activation status of each neuron in the forward propagation outcome speculated at the time t(i) may be speculated using the biased ReLU outcome. That is, the activation status of each neuron may be understood as a result of reflecting the previous forward propagation outcome (i.e., activation tendency of each neuron).

B. Biased Weight Update with Activation History (AH)

For continual learning, if important weights for a previous task are isolated and less affected when training for other tasks proceeds, it may help preserve retained knowledge. When training a model for different tasks, two patterns of activated neurons were found: (a) While training a specific task, neurons activated in the past tend to be activated even in the future and neurons deactivated in the past tend to be deactivated even in the future. That is, the activated neurons are highly likely to be continuously activated and the deactivated neurons are highly likely to be continuously deactivated. (b) The activated neurons differ from task to task. That is, neuros to be activated differ for each task. Only the activated neurons affect a speculation result (inference result) and play an important role in a corresponding task due to ReLU. The ReLU passes an input value to a next layer upon activated and propagates zero to the next layer upon deactivated. When experimented with a multi-layer perceptron for Permuted MNIST Handwritten and Fashion, activation probabilities of the same neurons were 87.8% and 84.2%, respectively. FIG. 2 illustrates an example of activated neurons in task 1 and task 2. Blue neurons and green neurons represent the activated neurons in task 1 and task 2, respectively. A neuron with an orange circle is activated both in task 1 and task 2. Activation probabilities of the blue neurons in task 1 are 81% and 77.2% on average for Handwritten and Fashion, respectively. Activation probabilities of the green neurons in task 2 are 88.6% and 88.1% on average for Handwritten and Fashion, respectively. That is, the blue neurons in task 1 tend to be continuously activated and the green neurons in task 2 tend to be continuously activated. Therefore, weights connected to the blue neurons and the green neurons may be said to be important in task 1 and task 2, respectively.

Algorithm 3 refers to an algorithm related to a method of updating weights according to activation history and Table 2 shows description related to terms used in Algorithm 3. A variable called activation history (ahⱼ) stores an activation tendency of a neuron while training for previous tasks. Therefore, the activation history may also be referred to as the activation tendency and may represent the activation tendency as a predetermined range (e.g., range of real number greater than or equal to 0 and smaller than or equal to 1). For example, when the activation tendency is 0.5, it represents that the number of cases in which a corresponding neuron is activated is equal to the number of cases in which the corresponding neuron is deactivated. Likewise, when the activation tendency is smaller than 0.5, it represents that the number of cases in which the corresponding neuron is deactivated is greater than the number of cases in which the corresponding neuron is activated. When the activation tendency is greater than 0.5, it represents that the number of cases in which the corresponding neuron is activated is greater than the number of cases in which the corresponding neuron is deactivated. Also, 0.5 in line #3 of Algorithm 3 may vary. For example, the activation history may be compared to a value smaller than 0.5 or a value greater than 0.5. Weight update followed by forward propagation and backpropagation may be repeatedly performed until each of weights included in the deep learning model converges to a predetermined range (or until a target error rate is reached).

After training for each task (i.e., after training for a single task is completed), uh, is adjusted with the biased ReLU computed in Algorithm 1 (line #7). r specifies a degree of weight update and directly affects knowledge preservation performance. In proportion to r, weights connected to activated neurons in the past are updated less (line #3-4) when training for a new task. That is, when training for the new task, it is possible to preserve knowledge learned from a previous task by limiting update for weights that play an important role in a past task or by barely performing updating. Table 3 shows the experiment result that reports accuracies of task 1 according to r, after sequentially training Permuted MNISTs (task 1 to task 4). For each distinct selection of r, the accuracy is higher compared to normal training (baseline), indicating that retained knowledge is better preserved. In general, a better result tends to be derived as r gets smaller. Accuracies reach the highest with r=0.3 for MNIST Handwritten and with r=0.4 for Fashion. However, it can be known that accuracy for the new task is degraded when r is too low. For example, when r=0.1, the accuracy of task 4 is 98.3% on average, which is 0.7% lower than the baseline (99%). This is because some neurons (e.g., neuron in an orange circle in FIG. 2) are activated for both previous and current tasks. In such a case, a tiny r indicates that weights connected to the activated neurons in the past are minimally trained for the new task. According to the experiment, 47.2% of neurons were commonly activated both for task 1 and task 2, and 49.8% of neurons were commonly activated both for task 2 and task 3. The weights connected to the neurons affect inference for both tasks. Therefore, to balance knowledge retention and new learning, it is important to find appropriate r. Empirically, r=0.3 may be a right selection for preserving knowledge and for training for a new task. When r=0.3, accuracies of previous tasks were roughly 15.1% higher on average than a reference value (baseline) without accuracy loss for the new task.

[Algorithm 3]
Algorithm 3 Biased Weight Update According to Activation History

```
1: while weight not converged do
2: g < ∇_{w}f(w) (get gradients with objective function)
3: if altⱼ^{l} > 0.5 do (if the neuron is activated with
  high probability for the previous task)
4: g ← g · r (reduce the gradients of the weights)
5: w ← w − η · g (update the weight)
6: end while
7: ahⱼ^{l} ← (ahⱼ^{l} + f(uⱼ^{l})′)/2; (accumulate biased ReLU
  to activation history after training each task)
8: return w
```

TABLE 2

| Notation | Description |
|---|---|
| w | weight of neural network |
| f(w) | gradient descent objective function with weight |
| g | gradient |
| ahⱼ^{l} | ReLU activation history of the previous tasks |
| r | rate of biased weight update (0 < r < 1) |
| η | learning rate |
| f(uⱼ^{l})′ | biased ReLU |

TABLE 3

| weight update degree (r) | r = 0.1 | r = 0.2 | r = 0.3 | r = 0.4 | r = 0.5 | r = 0.6 | r = 0.7 | r = 0.8 | r = 0.9 |
|---|---|---|---|---|---|---|---|---|---|
| MNIST Handwritten | 91.10% | 91.11% | 92% | 91.8% | 91.83% | 89.97% | 85.12% | 83.1% | 82.69% |
| SB accuracies | | | | | | | | | |
| MNIST Fashion | 60.70% | 60.72% | 61.35% | 61.61% | 61.42% | 57.01% | 52.83% | 48.46% | 45.19% |
| SB accuracies | | | | | | | | | |

### C. Mitigating Catastrophic Forgetting Using Both SB and AH)

Speculative backpropagation (SB) and activation history (AH) may be applied together to continual learning since the two methods are orthogonal. The speculative backpropagation (SB) is applied to Equation 1 to Equation 3 in a forward propagation process and applied to Equation 4 to Equation 6 in a backward propagation process. The activation history (AH) is applied to Equation 8 in a weight update process by Algorithm 3. Using both the speculative backpropagation (SB) and the activation history (AH) may further improve performance for continual learning.

A method of training a deep learning model based on speculative backpropagation and/or activation history according to an aspect of the present invention is described above. Hereinafter, a device for training a deep learning model based on speculative backpropagation and/or activation history according to another aspect of the present invention is described. In this regard, all the technical features and operation of each process related to the deep learning model training method and technical features, operations, and configurations of the deep learning model training device to be described below may be combined with each other. Also, the deep learning model described herein may include a neural network model, such as, an an artificial neural network (ANN), a deep neural network DNN, a convolutional neural network (CNN), a recurrent neural network (RNN), a restricted Boltzmann machine (RBM), a deep belief network (DBN), a generative adversarial network (GAN), a deep feedforward network (DFN), a long short-term memory (LSTM), an autoencoder, a variational autoencoder (VAE), a deep residual network (DRN), a graph convolutional network (GCN), and a spiking neural network (SNN).

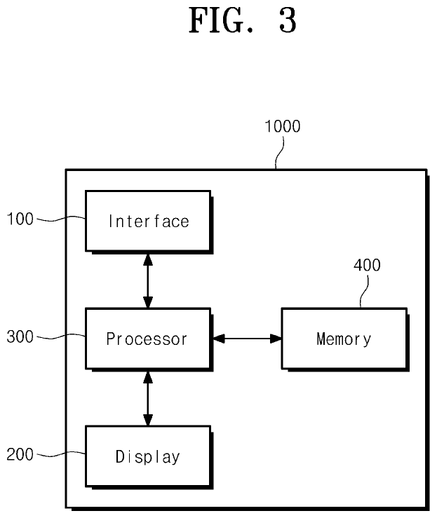

In this regard, FIG. 3 is a diagram illustrating a configuration of a device for training a deep learning model based on speculative backpropagation and/or activation history according to the present invention. When describing the deep learning model training device, description related to repeated contents of the foregoing description is omitted.

Referring to FIG. 3, a deep learning model training device 1000, also referred to as a deep learning model continual learning device, may include an interface 100, a display 200, a processor 300, and a memory 400. The interface 100 may be configured to input training data and/or test data corresponding to each of a plurality of tasks. The display 200 may be configured to compose data or results generated in a process of training the deep learning model and to display the same on a screen. However, the aforementioned interface 100 or display 200 is not considered as an essential component of the deep learning model training device 100. For example, when predetermined data is prestored in a storage device or a memory 400 that may be included in the deep learning model training device 100, all the operations may be automatically performed. Therefore, when a separate display operation is not required, the interface 100 and/or the display 200 may be omitted.

The processor 300 may be operatively coupled with the interface 100, the display 200, and the memory 400. The processor 300 may be configured to execute an (application) program capable of performing training for the deep learning model. The processor 300 may perform training for the deep learning model using received data/or pre-stored data for each of a plurality of tasks and may control a training result to be visualized on the display 200. At least a portion of operations included in the aforementioned deep learning model training method may be understood as an operation of the deep learning model training device 100 or the processor 300.

The processor 300 may be configured to perform training for the deep learning model for a next task based on activation history of neurons by a result of training for a previous task. That is, the processor 300 may be configured to execute training (for example, continual learning) for tasks each corresponding to each of a plurality of domains. In detail, the processor 300 may perform a forward propagation operation, a backward propagation operation, and a weight update operation for each task. The forward propagation operation, the backward propagation operation, and the weight update operation may be repeatedly performed until a predetermined condition is satisfied. Also, the processor 300 may perform the update operation based on an activation tendency of each of neurons included in the deep learning model, in a process for training for a previous task.

Also, the processor 300 may speculate a forward propagation outcome at a current time using at least one forward propagation outcome previously performed among forward propagation, backpropagation, and weight update processes repeatedly performed and may perform forward propagation and backpropagation in parallel (or simultaneously) at current time based on the speculated result.

The aforementioned method for continual learning according to example embodiments may be implemented in a form of a program executable by a computer apparatus. Here, the program may include, alone or in combination, a program instruction, a data file, and a data structure. The program may be specially designed to implement the aforementioned method for continual learning or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method for continual learning may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method for continual learning are described, the apparatus and method for continual learning are not limited to the aforementioned example embodiments. Various apparatuses or methods implementable in such a manner that one of ordinary skill in the art makes modifications and alterations based on the aforementioned example embodiments may be an example of the aforementioned apparatus and method for continual learning. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method for continual learning.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

Although the present invention is described with reference to example embodiments illustrated in the drawings, it is provided as an example only and it will be apparent to one of ordinary skill in the art that various modifications and equivalent other example embodiments may be made from the example embodiments. For example, suitable results may be achieved if the described techniques are performed in a different order, and/or if components in a described system, architecture, device, or circuit are combined in a different manner, or replaced or supplemented by other components or their equivalents. Therefore, the true technical protection scope of the present invention should be determined by the technical spirit of the claims.

What is claimed is:

1. A continual learning method of a deep learning model performed by a computing device comprising at least a processor, for continual learning for a second task and an n^{th} task for the deep learning model trained for a first task, the continual learning method comprising:
a forward propagation operation of performing a forward propagation;
a backward propagation operation of performing a backward propagation; and
a weight update operation of performing a weight update,
wherein the forward propagation operation, the backward propagation operation, and the weight update operation are repeatedly performed, and
the update operation is performed based on an activation tendency of each of neurons included in the deep learning model, in a process in which training for the first task proceeds.

2. The continual learning method of claim 1, wherein the forward propagation operation, the backward propagation operation, and the weight update operation are repeatedly performed until weights of the deep learning model converge to a predetermined range.

3. The continual learning method of claim 1, wherein the weight update operation limits weight update for a neuron of which activation tendency has a value greater than a predetermined value in the process in which training for the first task proceeds.

4. The continual learning method of claim 1, wherein the weight update operation comprises:
obtaining a gradient;
for a neuron of which activation tendency has a value greater than a predetermined value in the process in which training for the first task proceeds,
reducing a weight by multiplying the obtained gradient by a predetermined constant (r); and
updating the weight using the reduced weight.

5. The continual learning method of claim 1, wherein, in a training process for the second task, the forward propagation operation and the backward propagation operation that are repeatedly performed proceed in parallel at least once.

6. The continual learning method of claim 5, wherein the backward propagation operation that proceeds in parallel speculates a forward propagation outcome at a current time based on a result of the forward propagation operation of at least a previous time and performs backward propagation based on the speculated result.

7. A method of training a deep learning model performed by a computing device comprising at least a processor, the method comprising:
a forward propagation operation of performing a forward propagation;
a backward propagation operation of performing a backward propagation; and
a weight update operation of performing a weight update,
wherein the forward propagation operation, the backward propagation operation, and the weight update operation are repeatedly performed, and
the forward propagation operation and the backward propagation operation that are repeatedly performed after an initial execution proceed in parallel at least once.

8. The method of claim 7, wherein the backward propagation operation performed in parallel at a time t=i is performed using a forward propagation outcome at a time t=i that is speculated using a forward propagation outcome at a time t=(i-1) and a forward propagation outcome at a time t=(i-2).

9. The method of claim 8, wherein the forward propagation outcome speculated at the time t=i is speculated by assigning a greater weight to a result of the deep learning model at the time t=(i-2) than a result of the deep learning model at the time t=(i-1).

10. The method of claim 8, wherein an activation status of each of the neurons at the time t=i is speculated based on the activation tendency of each of the neurons included in the deep learning model up to the time t=i-1.

11. The method of claim 7, wherein, in a training process for a second task performed after training for a first task is completed, the update operation is performed based on an activation tendency of each of neurons included in the deep learning model in a process in which training for the first task proceeds.
